(19) United States
(12) Patent Application Publication
(10) Pub. No.: US 2017/0178047 A1
(43) Pub. Date: Jun. 22, 2017

(54) Quality Assurance Systems and Methods Associated Therewith

(71) Applicants: Steve Schroeder, Glencoe, IL (US); Robert Christopher Pirotte, Chicago, IL (US); Eric Becker, Schaumburg, IL (US); John Nienhuis, Marengo, IL (US); Andy Centeno, Chicago, IL (US)

(72) Inventors: Steve Schroeder, Glencoe, IL (US); Robert Christopher Pirotte, Chicago, IL (US); Eric Becker, Schaumburg, IL (US); John Nienhuis, Marengo, IL (US); Andy Centeno, Chicago, IL (US)

(21) Appl. No.: 14/974,472

(22) Filed: Dec. 18, 2015

(51) Int. Cl. G06Q 10/06

(52) U.S. Cl. CPC G06Q 10/06395

(57) ABSTRACT

A new and improved quality assurance system and associated methods are disclosed that allow for data collected and input electronically via tablets or mobile computing devices in real-time. The input data is collated to allow for review against established product rules that will drastically decrease the time it takes for manufacturers to release batches of quality approved products.

### FIELD OF THE INVENTION

The present invention relates to improved quality assurance methods that allows for data collected electronically in real-time and collated to allow for review against established product rules that will drastically decrease the time it takes for manufacturers to release batches of quality approved products.

### BACKGROUND OF THE INVENTION

Ensuring the safety of food supplies throughout the manufacturing process (ingredients, components, handling, processing, packaging, storing, and distribution) continues to play an integral part for food packagers/manufacturers. Worldwide programs such as the Global Food Safety Initiative (GFSI) and its partners (SQF, BRC, ISO, etc.) and the US Food Safety Modernization Act (FSMA) demonstrate the importance that regulatory bodies are placing on the manufacturing of food products introduced to the populations.

In the U.S., the Code of Federal Regulations establishes the requirements for quality control and batch release at 21 CFR 1.111 et seq., as well as the requirements for records and record keeping.

To meet these many standards and regulations, food manufacturers establish a quality assurance process that is executed by performing a multitude of quality control checks at established time intervals. These checks are often performed by technicians from quality or operations roles, recording the data that will be reviewed against set requirements in order for the manufacturer to release the batch, the amount of data diagnosed by these technicians is varied and extensive, often preventing them from proactively alerting management when results fail or begin to degrade. Additionally, the process is often executed on paper and involves a time consuming review process to ensure all the data meets the established requirements for batch release.

When data is taken on paper, technicians do not have the results of quality control checks readily available in real time. Likewise, if the data has to be transferred via the internet to a control room, the quality control checks are not usually readily available in real time. Having the quality control checks available immediately to the technician would allow decisions regarding packaging to be made more rapidly. If a machine is not working properly and if there is a delay in determining that that packaging machine is not working properly, there will also be a delay in fixing and/or addressing any issues associated with that packaging machine. The delays may mean that the packaging machine will pack goods/products improperly for an extended period of time whereas early determination would have allowed more prompt correction of that packaging machine.

Thus, if technicians were able to receive immediate feedback on results that failed to meet the release requirement rules, or were alerted to results that were conditional passes that could be early indicators of negative trends, then they could proactively alert management to place materials on hold or have operations adjust the manufacturing to prevent future material holds. This would generally reduce goods that do not meet code and/or law requirements and also might potentially reduce the amount of unsafe product reaching the consumer or others outside of the plant where the product is produced/packed/stored etc.

It is with these drawbacks and needs in mind that the instant invention was developed.

### BRIEF SUMMARY OF THE INVENTION

An object of the present invention is to provide a system and/or a method that checks the quality of goods in a real time setting so that goods may be processed and released for distribution more quickly.

In one embodiment, the present invention relates to data collected electronically in real-time and collated to allow for review against established product rules that will drastically decrease the time it takes for manufacturers to release batches of quality approved products.

In an embodiment, quality control plans can be determined for each product and, the checks required for release of the product and batch can be entered into a system at a desktop computer or tablet by an administrator. In one embodiment, the check may have one or more of the following options: texts, date/time, dropdown, average, toggle (pass/fail), weight audit, and count audit. In an embodiment, standards are customizable to allow data collection for many products and manufacturing processes, and any combination of check options may be used to create a quality control plan.

Checks that use numeric inputs (text, average, sum, weight audit, and count audit checks) have additional options that can trigger warnings and/or errors feedback if the entry result is greater or less than set target numbers. An additional option for numeric inputs is an Ideal Value which is used to determine and compare results in relation to a set value for the check.

Toggle checks also have the option to produce secondary checks in case of failure, and the option for a text response if either the first or second check fails.

Once the quality control plan has been completed, it is created, it is saved and then it can be published. Once published, the plan can be opened by technicians on the production floor allowing for a quality check of a product. Technicians access the quality control plans using an application on a Wi-Fi enabled tablet or alternatively on a smart phone. The technicians are alerted by conditional formatting if the check fails or meets/exceeds one of the predetermined warnings or errors. Once complete, the technicians will save and submit their quality checks, allowing the data to be reviewed for batch release by a designated administrator. Data can be compiled and reviewed after any number of submissions by a technician, allowing the batch length to be a single hour or an entire day.

### BRIEF DESCRIPTION OF THE SEVERAL VIEWS OF THE DRAWINGS

FIG. 1 shows a flow chart of one embodiment of a quality assurance process of the present invention with a focus on the creating of the quality assurance process.

FIG. 2 shows a flow chart of one embodiment of a quality assurance process of the present invention with a focus on the use by a technician on the production floor.

FIG. 3 shows a screen shot of the initial screen when creating a test standard

FIG. 4 shows a screen shot of a page that allows one to create a new standard or copy to a new standard

FIG. 5 shows a screen shot of a create standard page that allows one to break down into various sections as shown in the figure.

FIG. 6 shows a screen shot of a create standard page wherein after a section has been chosen, the edit checks tab allows one to access the check options.

FIG. 7 shows a screen shot of a create standard page wherein after a new section has been selected, the various checks shown in the figure can be selected and entered.

FIG. 8 shows a screen shot of a create standard page wherein general information section for a live standard was created. The text checks JOB ID and JULIAN DATE are text checks on this page and SITE is a dropdown check.

FIG. 9 shows a screen shot of a create standard page wherein the JULIAN DATE is ready for input of a number. There is an option on this page to allow one to set upper and lower limits for the JULIAN DATE.

FIG. 10 shows a screen shot of a create standard page that allows one to access ADD RANGE wherein one is able to set limits to the JULIAN DATE (for example, no greater than 367).

FIG. 11 shows a screen shot of a template page, which is the screen a technician would see when they conduct this test standard. The input of a JULIAN DATE greater than 366 gives an error (and the JULIAN DATE box turns red because 380 is greater than 367).

FIG. 12 shows a screen shot of a create standard page wherein the page exemplifies a text pair wherein the values are connected and allow for various inputs. The bottom area of the page is a text area.

FIG. 13 shows a screen shot of a create standard page that shows how text pairs are created and allows for the options of AlphNumeric, Alpha Only, and Numeric Only.

FIG. 14 shows a screen shot of a create standard page that shows a text area check creation or edit with no numeric only option.

FIG. 15 shows a screen shot of a create standard page with a date/time check.

FIG. 16 shows a screen shot of a create standard page that has an expiration date option that can alert the technician if the date is past due.

FIG. 17 shows a screen shot of a create standard page with a dropdown check wherein the options are separated by commas.

FIG. 18 shows a screen shot of a create standard page with six Toggle checks.

FIG. 19 shows a screen shot of a create standard page wherein when a Toggle check is created, one is given a pass (succeed)/Fail test choice. The test allows for an optional secondary test if the fail option is selected.

FIG. 20 shows a screen shot of how the section may look to the technician when the technician elects the pass and fail results. When the fail result is selected, the box with the fail may turn red.

FIG. 21 shows a screen shot of a create standard page wherein a secondary toggle may be present.

FIG. 22 shows a screen shot of a create standard page wherein when a first or a second toggle FAIL is chosen, a reason option may be present, which allows the technician to type in a specific answer.

FIG. 23 shows a screen shot of a create standard page wherein the AVERAGE check is the same as the WEIGHT and COUNT checks. One can elect to eit the conditional formatting for the average (using the EDIT AVERAGE RANGE).

FIG. 24 shows a screen shot of a create standard page wherein when one elects to edit the average, another upper/lower limit option may appear.

FIG. 25 shows a screen shot of a create standard page that allows one to click on the individual fields and set upper/lower limits.

FIG. 26 shows a screen shot of a template page that allows the technician to enter data on said page. Red warnings will occur for entered values that do not meet specifications.

### DETAILED DESCRIPTION OF THE INVENTION

Machines have facilitated and increased the quantity, and also in many cases, the quality and uniformity of products and/or the packaging of products. However, as was discussed above in the Background of the invention, it is beneficial if information would be more rapidly available to ensure that the machines are performing as required. Thus, in one embodiment of the present invention, this invention relates to systems, methods and processes for getting information more rapidly regarding goods that are being manufactured/packaged. In an embodiment, the systems, methods and processes also relate to being able to more rapidly address problems associated with the manufacturing/packaging machines because the information regarding whether or not the machine is working properly is attained more rapidly. Accordingly, the manufacturing/packaging machines can be more rapidly repaired or adjusted so as to assure that the machine is meeting the requisite checks.

In an embodiment, the present invention relates to the implementation of a quality assurance process. In one embodiment, the quality control plans are determined for each product and, the checks required for release of the product and batch are entered into the system at a desktop computer or tablet by an administrator. Each check can have one of the following options: texts, date/time, dropdown, average, toggle (pass/fail), weight audit, and count audit. Standards are customizable to allow data collection for many products and manufacturing processes, and any combination of check options may be used to create a quality control plan.

If one or more of the combination of check options is not met, a quality assurance process is in place that allows one to disposition negatively affected product.

Checks that use numeric inputs (text, average, sum, weight audit, and count audit checks) have additional options that can trigger warnings and/or errors feedback if the entry result is different or greater or less than set target numbers. An additional option for numeric inputs is an Ideal Value which is used to compare the acquired result(s) in relation to a set value for the check. Toggle checks also have the option to produce secondary checks in case of failure, and the option for a text response if either the first or second check fails.

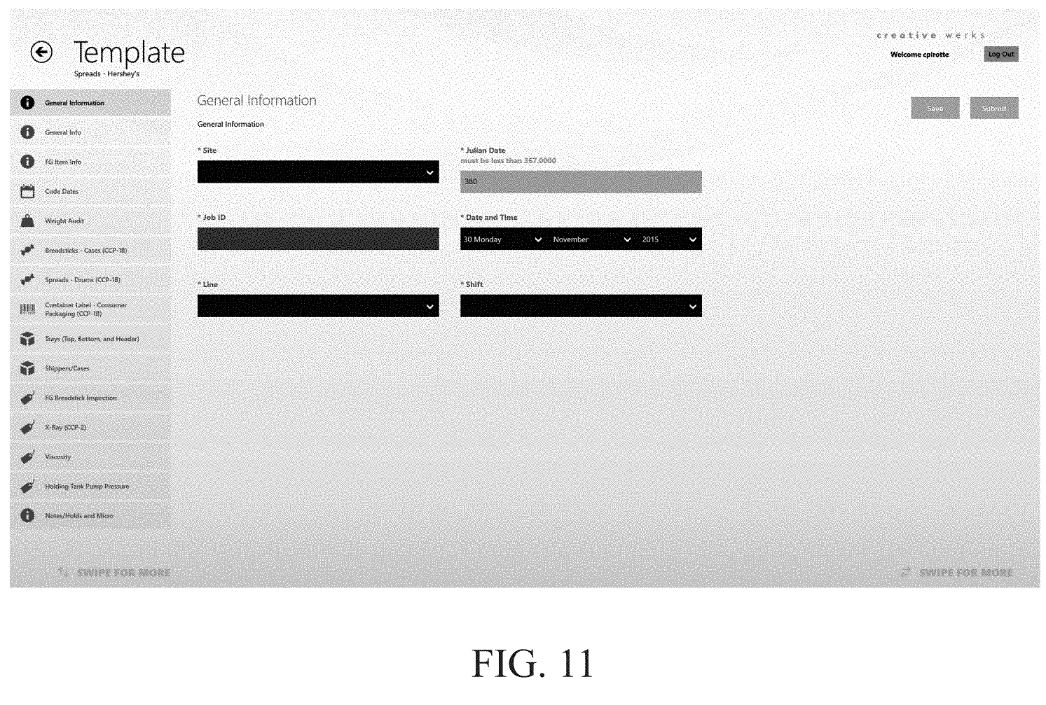

Once the quality control plan has been completed created, it is saved and published. Once published, the plan can be opened by technicians on the production floor allowing for a quality check of a product on the floor (see FIGS. 11, 20, and 26). Technicians access the quality control plans using the application on a Wi-Fi enabled tablet. The technicians are alerted by conditional formatting if the check fails or meets/exceeds one of the predetermined warnings or errors. In one embodiment, once complete, the technicians will save and submit their quality checks, allowing the data to be reviewed for batch release by a designated administrator. Data can be compiled and reviewed after any number of submissions by a technician, allowing the batch length to be instantaneous, a single hour, or for an example, an entire day.

### Advantages

The present invention possesses a plurality of advantages that are not seen in the quality assurance systems of the prior art. One advantage is that the present process allows user interface by a technician on a tablet or smart phone that allows for immediate conditional formatting feedback if a result does not meet one or more specifications. Previously, without this immediate feedback, the production process may have continued for a period of time possibly exacerbating errors that were in the production process.

In an embodiment, another advantage of the present invention is that it allows for mobile input devices. In a variation, the application works on tablets, allowing technicians to move from line to line and perform different checks while carrying their input device with them and also allowing for instant feedback. In one variation, it is contemplated and therefore within the scope of the invention that smart phones may possibly be used to create even more flexibility. By having the technician work with these mobile devices wherein data is immediately input and checked against standards (that have been input by an administrator), the check will allow the technician to immediately know if the quality check meets the requisite quality standards. If it does not, the manufacturing process can be stopped and/or immediately rectified to make sure that the requisite quality standards are attained.

By tablet, it is meant a mobile computer device that has the ability to store and process data.

In one variation of the process, weight/count audit checks may be performed. In an embodiment, these checks allow a technician to average the samples taken during the check (e.g. 10 samples for example) and provide conditional formatting feedback if the results are out of specification for not only the individual samples but also for the overall samples average.

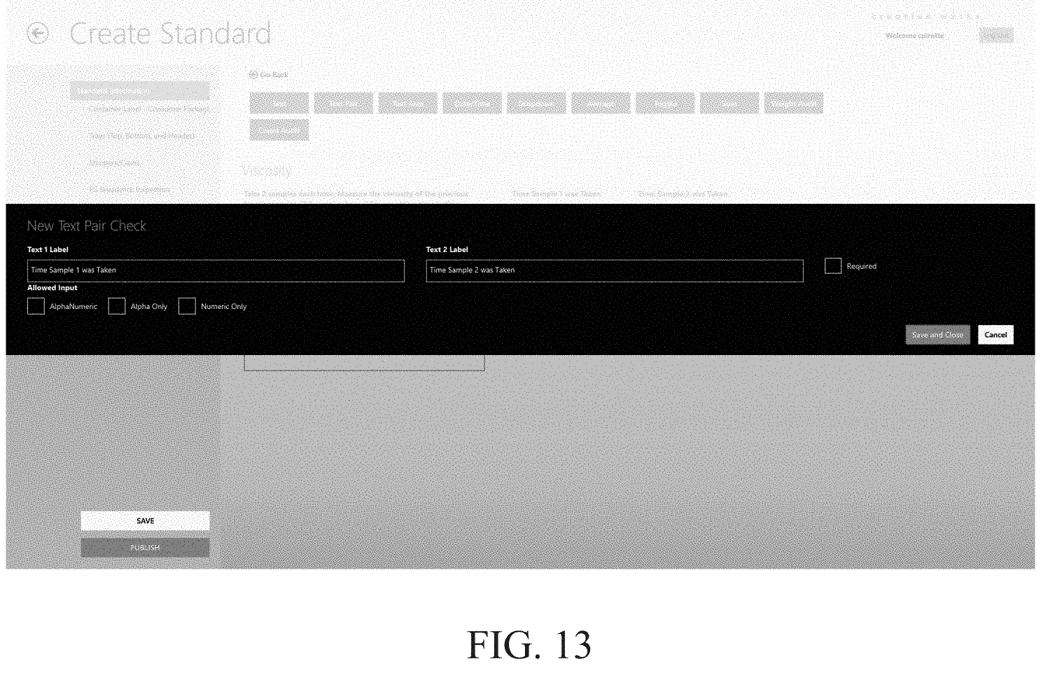

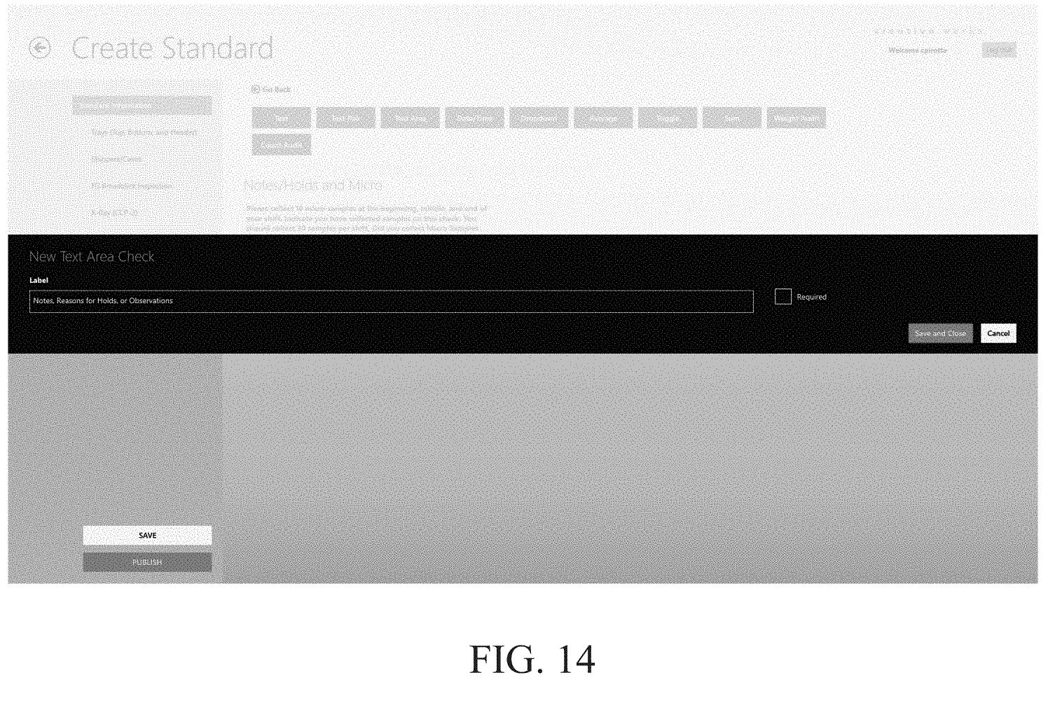

In one embodiment, the checks can be grouped together. For example, checks can be grouped into Sections, and the quality plans may have sections with multiple checks in each section, allowing for technicians and batch release reviewers to access checks that are related or need to be grouped for ease of review or testing. For example, a count check might be connected with a weight or average weight check to ascertain the correct number of products of a defined range of weights are packaged together. (see FIG. 13-14)

Not only does the quality control process/system of the present invention allow instantaneous feedback on individual units of production, but the system/process is also designed to be used for batch release. In an embodiment, a group of quality checks once completed can be reviewed to determine if the batch can be released. In an embodiment, for each check, technicians receive conditional formatting feedback for warnings/errors that are readily seeable/ascertainable on the mobile device screen to allow for easier approval (rather than waiting for data crunching by an administrator/manager at a later time).

In one embodiment, the present invention relates to a system/process that has warning and error limits which can be manipulated based on the product being audited.

In an embodiment, the present invention has an ideal value that can be used to determine deviation from a target for net weight and count audits. In a variation, the deviation may show up automatically in another box.

In an embodiment, the present invention has real time color formatting to notify the user of any errors. In a variation, a deviation may show up automatically in another box and if the deviation from the standard is small and below an acceptable deviation amount, the background may be green (or white or remain unchanged), if it is in a range to monitor or with a warning, it may show up with a yellow background and if the deviation is too large (or the product does not meet specifications) it may show up with a red background.

In one embodiment, the present invention has averages and sums which are automatically calculated. In a variation, if the average and sums are too large (i.e., beyond an acceptable deviation amount), the background may be appropriately colored to indicate that the deviation is too large (e.g., be red).

In an embodiment, the present invention relates to systems/processes wherein the system/process has the ability to use local database to store information and easily create reports. Accordingly, it is contemplated and therefore within the scope of the invention that wireless technology may be used to create these reports. It is also contemplated that if one section of a company is working on a secret project that wireless technology and any data associated with that secret project may not be readily available.

In one variation, the reports that can be generated may be customizable with access to raw data. For example, a technician may tap the screen (or use a mouse or a stylus) for a “create a report” and then tap the screen (or use a mouse or a stylus) with the checks that are to be included in the report. These reports may be useful for batch release as discussed above as a number of checks may be compiled from over a period of time that will give information on batches.

In an embodiment, the systems/processes of the present invention are laid out in a fashion that allows not just easy access of data but may also present the data in such a way as to be easily readable/interpretable. In one embodiment, the systems/processes of the present invention are laid out for tablet viewing, and standards may be searchable by item, description, and/or client. Boolean operators may be a part of the systems/processes of the present invention, which allows for one to search different groups (item, description, and/or client) by Venn diagrams (or in a comparable manner).

In one embodiment, the process/system of the present invention may allow users to toggle between different user types based on their permissions. For example, a technician who is working on a secret production may be able to access a user type that allows said technician greater access to information associated with that secret production. Alternatively and/or additionally, multiple user types are available that can be customized to a specific need. For example, a technician may have a user type that is one or more of sensory. QA (quality assurance), or maintenance, or some other user type (e.g., global). In this embodiment, the data that is available the type of user may be partitioned so that the user is not burdened by irrelevant data (to that user type). Rather, data may be classified so that someone with a user type that is maintenance has access to data that is maintenance related. Stated differently, in one embodiment, users may be restricted to designated standards based on their access.

In one embodiment, the process/systems of the present invention may have automatic version numbering. For example, lot codes, items, scale readings, and other numbers may be entered with the use of a peripheral device (such as a scanner, scale, etc.). This should reduce the occurrence of errors as the technician may not be required to manually input the data. It is contemplated that questions may be asked of the technicians when a peripheral device is used to ascertain if the technician believes that the peripheral device is working as intended.

In one variation, the data necessary for entering and/or interpreting the quality assurance may be present on the mobile device and not on a centralized computer system. This allows the technician to make instantaneous decisions based upon the data the technician is entering/gathering. This provides for a system/process that allows production processes to be altered and/or stopped more rapidly, which allows for higher production yields (as products that may not meet specification are created/manufactured/packaged for shorter periods of time—that is, corrections are made more rapidly). Alternatively, as data is input/gathered by the technician on the floor, the data may be not only accessible to the technician but may also be instantaneously transmitted to a second computer system that allows a user with a more global user profile to readily access the data that is being entered/gathered by the technician on the floor.

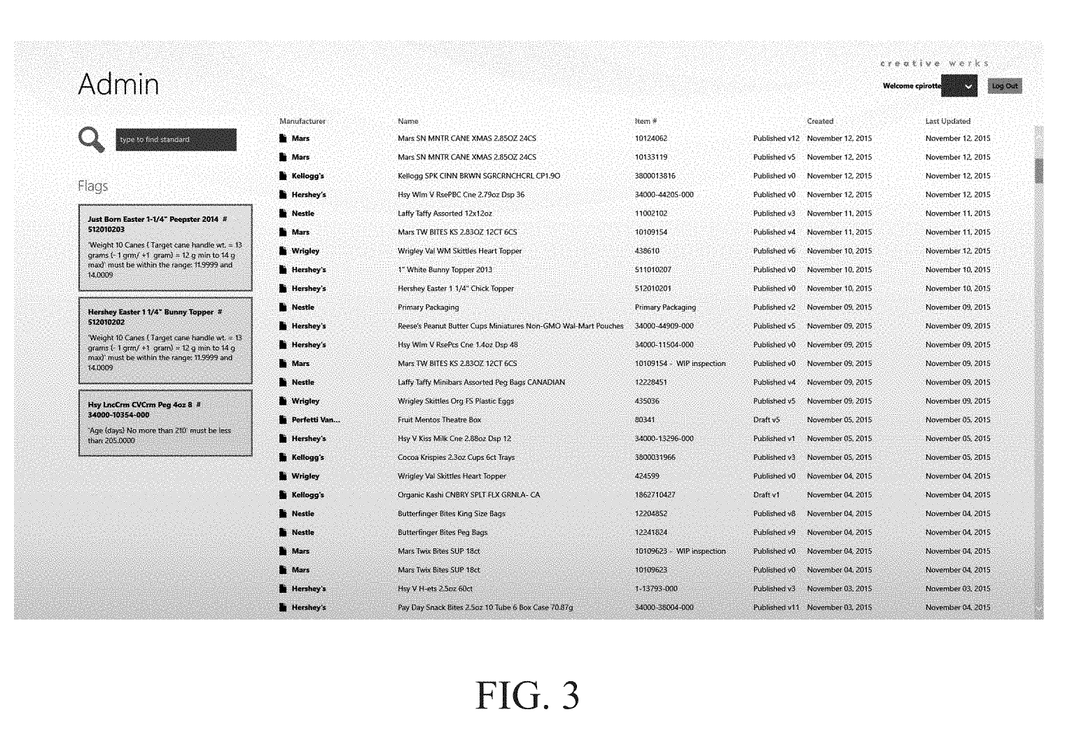

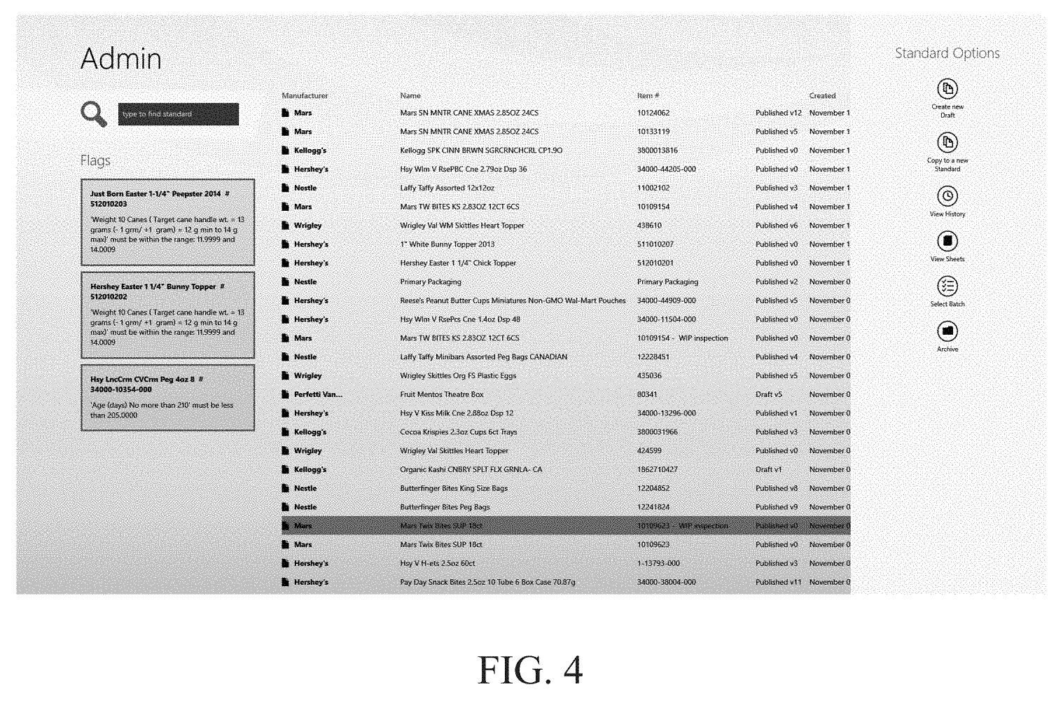

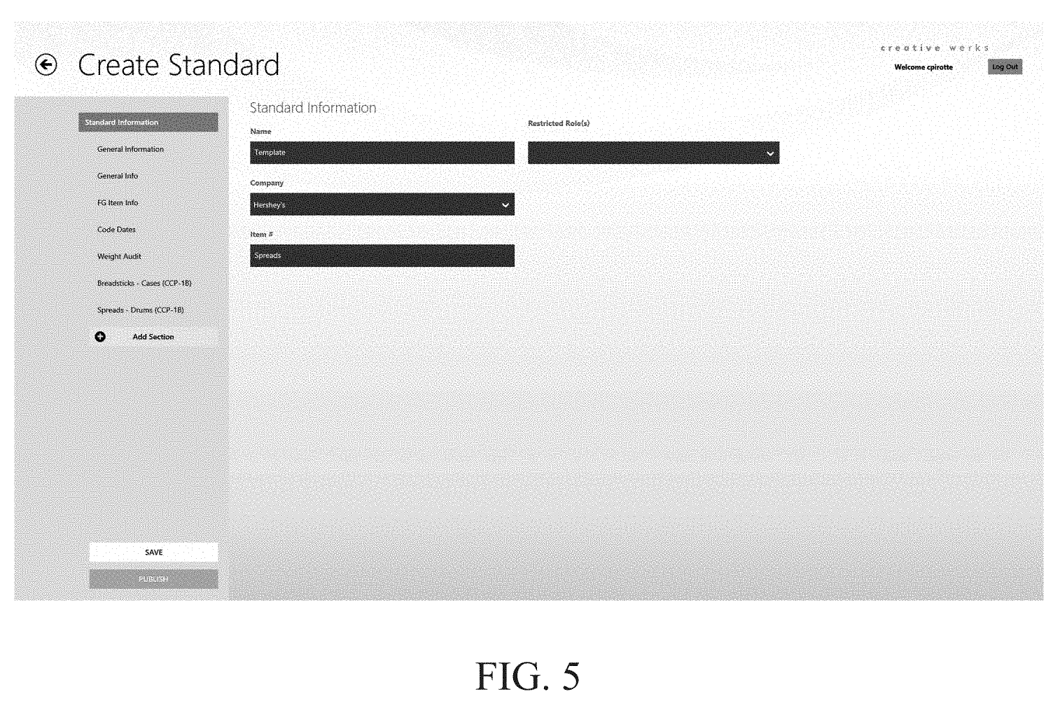

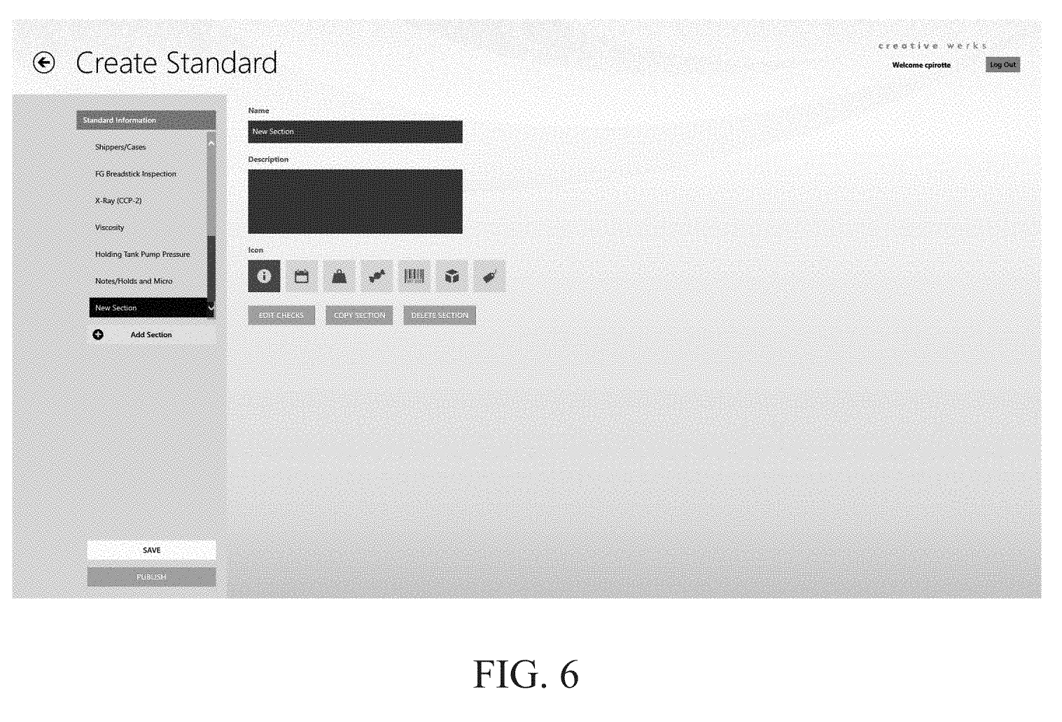

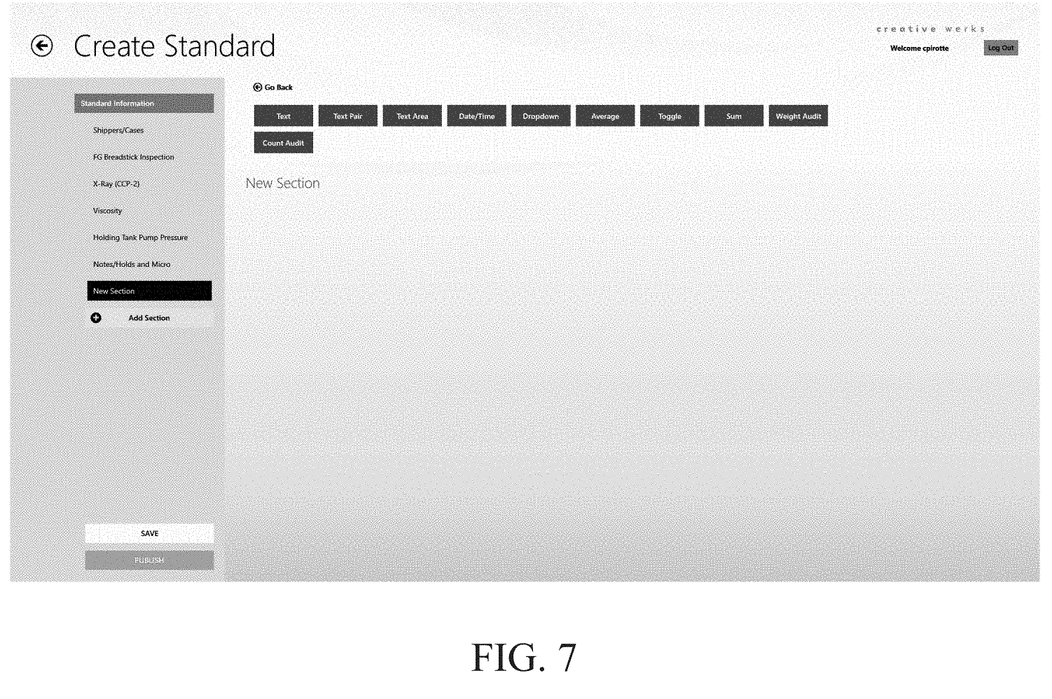

In one embodiment of the invention, an administrator may plan and create a quality assurance process and the process may be created as follows. An administrator may have access to a user profile as an administrator that allows only administrators permission to create that quality assurance process. An initial screen may appear when creating a testing standard and that screen may contain the names of clients (see FIG. 3). A client may be selected (by mouse, tapping the screen, or a stylus) and the sub menus under that client may appear that represents products/processes that have been created for that client. It should be understood that by client, the client may be an external client (wherein the manufacturer is creating/packaging/manufacturing for said external client) or the client may be internal. Once the sub-menu(s) appear(s), the product/process of that client may be selected. The submenu(s) may also offer the choice of copying an old standard to a new standard or creating a completely new standard (see FIG. 4). If an old standard is copied to a new standard, that new standard can be modified. If a new standard is created or a saved standard modified, there may be submenus that provides for a number of sections (see FIG. 5). For example, the sections may contain additional information like general information, item information, code dates, or other information. The sections may have a series of checks associated with them. For example, the checks may be broken down into one or more of the following options: texts, date/time, dropdown, average, toggle (pass/fail), weight audit, and/or count audit or other options. Generally, one chooses a section that is given a name and then the checks can be accessed by clicking, for example, and “edit checks” link that allows one to access the check option (see FIG. 6). Once the new section is created and the checks properly edited a screen will appear that has the new section with the various checks that have been selected to be a part of that section (see FIG. 7).

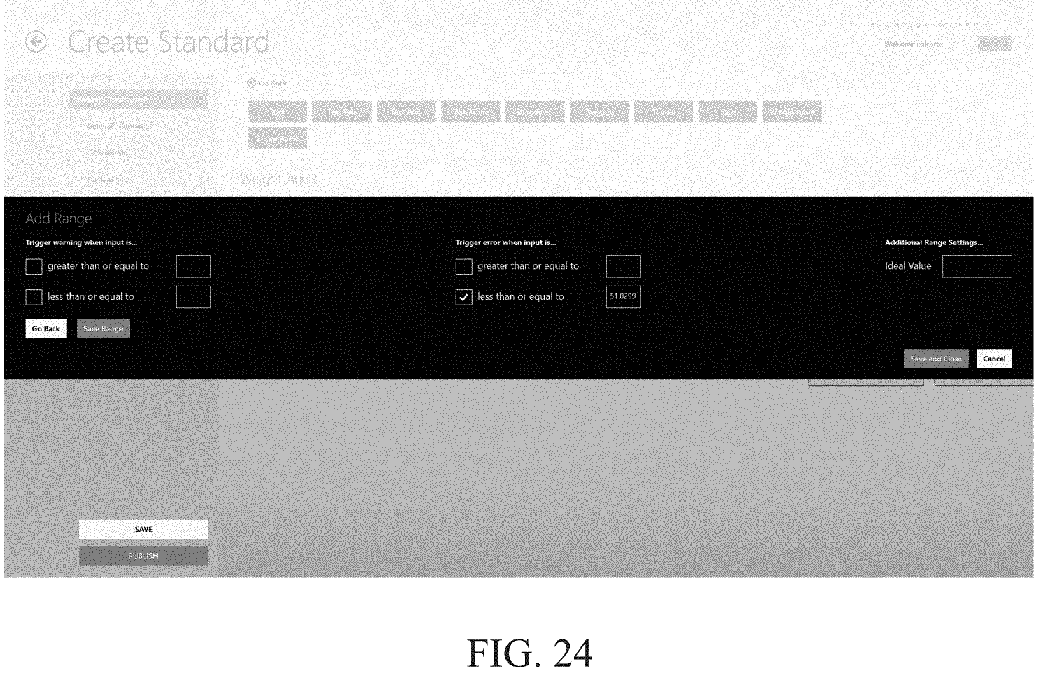

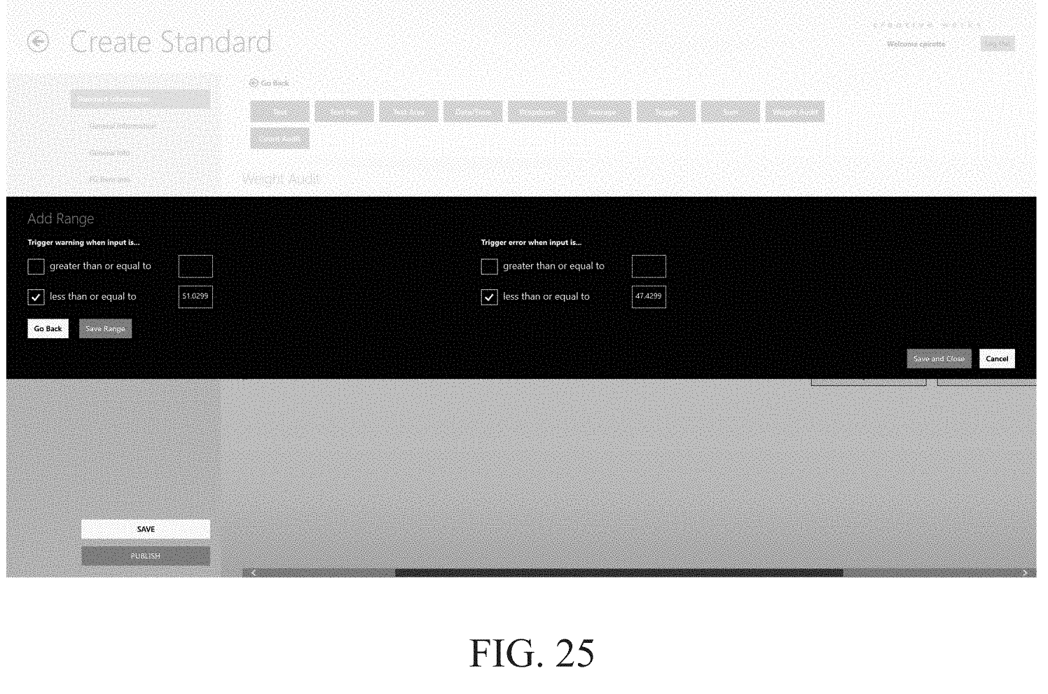

It should be understood that the checks may allow numerical input, it may be input by a peripheral device, or there may be a toggle (e.g., yes or no). The checks may have limits (or range limits set by upper and lower limits) associated with the check (see FIGS. 24-25) that when data is entered into the check, the check may output information that can be used by the technician. For example, and as discussed above, the background of the check may indicate a color if the deviation from a standard is too much, or alternatively, if the check has exceeded some expected value. The administrator that is setting up the check may have various submenus associated with each of the checks that allow the appropriate input check be entered. For example, the administrator may set up the check with a limit, with a range, or with a toggle and associated question. For example, if a limit is set, the administrator may be presented with a screen that says “trigger limit when input is greater than or equal ______”. In the blank, the administrator would enter the limit. There would also be a corresponding limit that says “trigger limit when input is less than or equal ______”. Thus, if information is entered by the administrator for both blanks, the technician will have a range.

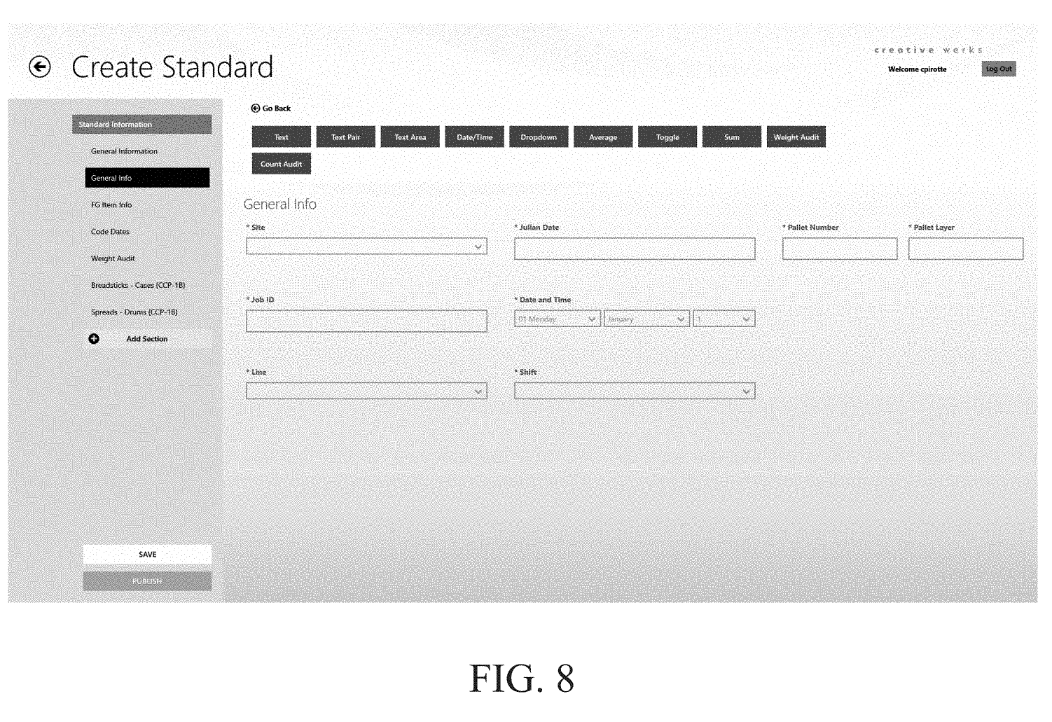

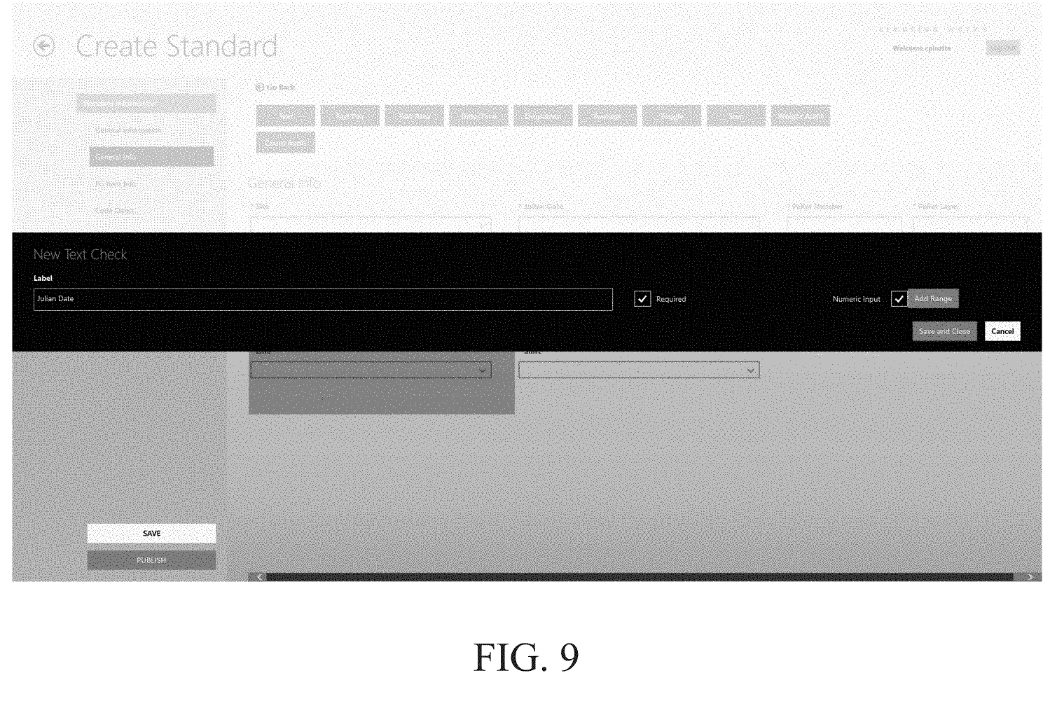

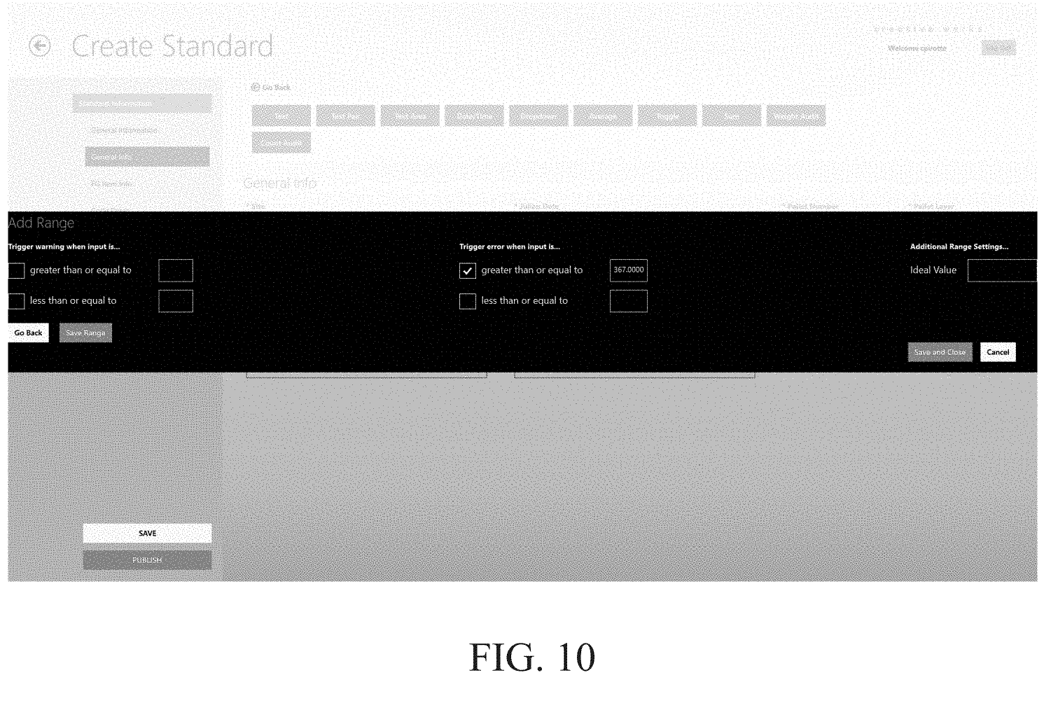

If, for example, the administrator indicated that the Julian date (the day of the year) needed to be input, the administrator might input data in the “trigger limit when input is greater than or equal ______” of 366 (as this is the maximal number of days that a year may have). After the administrator has entered, for example, the above information, the technician if he input “380” for the Julian date, the background of the Julian date would turn red, indicating that the technician exceeded the triggering input (see FIGS. 8-11). In one embodiment, the technician may not be able to enter any other data until the Julian date is corrected. Alternatively, the technician may be able to enter other data, but the red background would stay on the Julian date and at a later point, may need to be corrected (or a comment might have to be made by the technician indicating why the technician continued with input with an incorrect Julian date). Although the above example is illustrated with respect to a Julian date, it should be understood that any of the checks may exude a red background if they are exceeded or an acceptable deviation or acceptable value is not input.

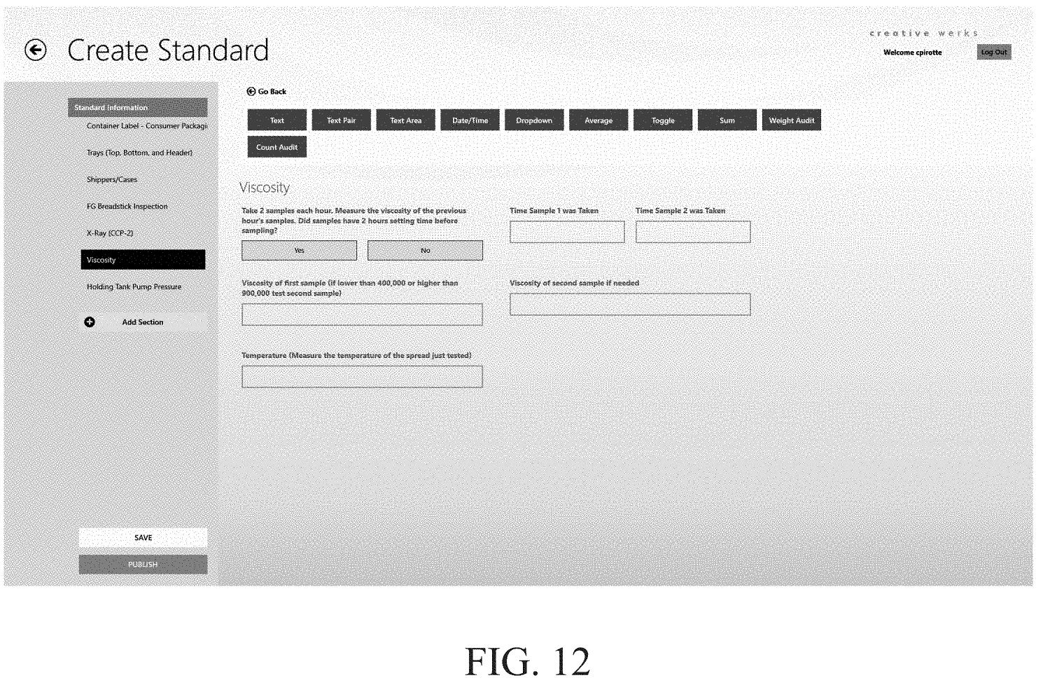

In an embodiment, the check may allow for the creation of yes/no buttons (created by toggle checks) (see FIG. 12). For example, a technician may be asked if the technician sampled the requisite number of samples to get sufficient data. For example, the yes/no question may say “did you open at least five packages to check for broken product”. If the technician enters “yes” then additional questions/blanks may appear that allow for the entry of further data. For example, if the product is easily breakable (e.g., breadsticks), there may be boxes that allow the technician to enter the number of broken breadsticks in a container. There may also be a query box that allows the technician to enter comments about the broken product. If the technician enters “no” for the question “did you open at least five packages to check for broken product”, a different series of questions may appear (all of which can be entered by the administrator). Other toggle checks are contemplated like acceptable/fail buttons. Any of a plurality of toggle boxes may be presented to a technician on any or on multiple screen(s). In any of the toggle checks, there may appear secondary checks that are given depending on the answer of the technician. For example, if a product fails a certain test, additional information may be sought. For example, if the technician is inputting data for the appearance of a product and the technician enters “fail”, there may be a secondary check that asks the technician questions as to why the appearance of the product failed. The secondary check may be another toggle, or for example, may require the input of text, or alternatively, may be selected from a dropdown menu.

Alternatively and/or additionally, the administrator rather than using yes no buttons may create a text box that says “enter the number of boxes that were checked for product”. If a sufficient number of boxes was not opened and the technician enters a number that does not meet the requisite number, the box may turn red and give an error warning. For example, it may say “at least 5 boxes must be checked.”. The process may not allow input of additional data until the requisite minimum number is met/checked. Generally, any time that a numeric value is requested, the underlying program allows for limits and/or range limits that can be input by the administrator. When the administrator enters a text box that asks for alphanumeric information, there generally is no allowance for limits and/or range limits (see FIG. 14).

In an embodiment, the technician may be faced with questions that may or must be answered. For example, the technician may be required to input an expiration date as shown on a product box. In this instance, the expiration date may be entered by a bar code scanner wherein the technician simply scans a bar code which contains information regarding the date. If the expiration date has passed, the technician may get an alert that indicates that the expiration date is past due.

In an embodiment, the check may also include a dropdown check, wherein the administrator allows the technician a series of choices from a drop down menu. For example, the technician may be asked where the technician is. There may be a possible number of potential sites that the technician can use a dropdown menu to select. If a certain site is selected, another dropdown menu may appear asking the technician, for example, what product he is checking (where there are choices for a number of possible products).

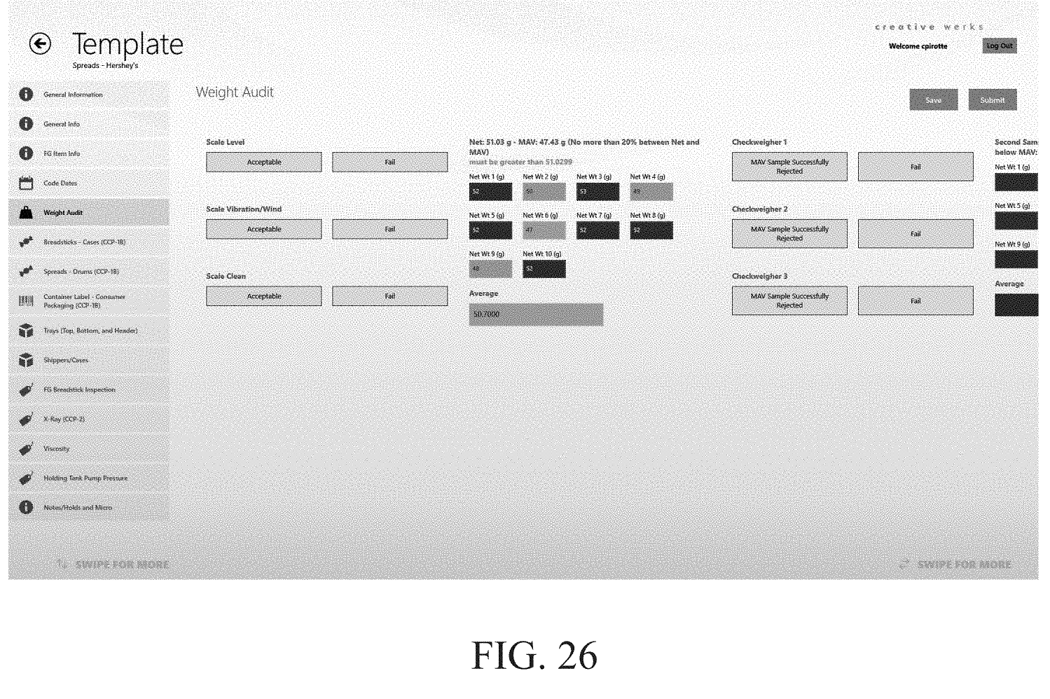

In an embodiment, the technician may enter count number and may have a peripheral device enter a value that corresponds to a count value. For example, if the technician is required to test the weight of five products, the technician might enter the weight for each of the five tested products (or alternatively, a peripheral device, such as a scale, may input the data). If, for example, all five of the products meet a minimum weight (and for example, give a yellow warning background) but, all are below the average weight, the sum of the five weights might potentially not meet specifications and the sum of weights might give a warning alert (indicated by a red background) (see FIG. 26). The technician might stop and/or alter production to address the problem so that the sums of weights are within an acceptable deviation.

The technician may be asked to conduct further checks to ascertain if the tested samples were merely an outlier and the production process is going as desired.

In an embodiment, the quality assurance process and associated methods may also have a photograph check. This photograph check enables the technician to take a relevant photo to ensure that something is as reported (e.g. a check for lot code would have a photograph check as well to ensure that the lot code really was as stated) or as an opportunity to communicate an issue (e.g. in the final tab which is usually Notes/Comments, the technician may indicate that the packaging film is blurry and would take a photo as an example for record of their findings). Although checks that rely on input by the technician are valuable, the photograph check provides a memorial to any problem that may have occurred. The camera that is used for the photograph check may be a part of the tablet or mobile computing device. Alternatively, the technician may have a camera that is able to download/upload photos on to the tablet so that it can be memorialized/saved for later viewing. The photo may also be able to be viewed in a pop-up or in a new window. In one variation, the technician may be required to take a photo if certain information is input when performing other checks. In one variation, the technician may not be allowed to proceed with other checks absent a photograph being taken. In one embodiment, when certain data/information is entered, the camera application may automatically be activated allowing the technician to take a picture.

Thus, in an embodiment, the present invention relates to systems, processes and methods. In one embodiment, the present invention relates to a quality assurance system for ascertaining the quality of packaged and/or manufactured goods, wherein said system comprises one or more tablets and/or mobile computing devices that allows for a user to collect and input data on said goods on said one or more tablets and/or mobile computer devices, wherein said data is collected and input in real-time and collated in real time to allow for substantially instantaneous review against established product rules, said instantaneous review against established product rules allowing the user to ascertain the quality of the packaged and/or manufactured goods.

By instantaneous review, it is meant that the input data that is input onto the tablet and/or mobile computing device has software on it that allows said tablet and/or mobile computing device to take the input data and compare it to a standard check. The tablet and/or mobile computing device will output a result wherein the result gives information that allows the user to ascertain if the quality of goods meets specification. The input data does not have to be transferred to a second computing device to ascertain the quality of the goods but rather the tablet and/or mobile computing device is able to give that information immediately (for example, in less than a second).

In one variation of the process/method or system, the established product rules are input by an administrator. The administrator can use any of the plurality of methods to input established product rules as are discussed above. In one variation, the established product rules comprise checks that the user uses as a guide to collect and input data on said goods on said one or more tablets and/or mobile computer devices.

In one variation, the checks comprise one or more of data that can be collected by the user and input as text, input from a dropdown menu, or input using a toggle.

In an embodiment, the system further comprises a mouse, a stylus, or a peripheral device that is used to input data.

In an embodiment, the peripheral device is one or more of a weigh scale, a bar scanner, a temperature reader, a moisture sensor, a RFID sensor, and a counter that comprises a light beam used for counting including counters that use lasers for counting purposes.

In an embodiment, the system may also comprise a pass/fail toggle that allows a user (e.g., a technician) to choose either pass or fail. The user may select either pass or fail by depressing the screen in the appropriate spot (e.g., where two table screen boxes correspond to either pass or fail). If fail is chosen, a secondary check may occur that requires a user to input additional data.

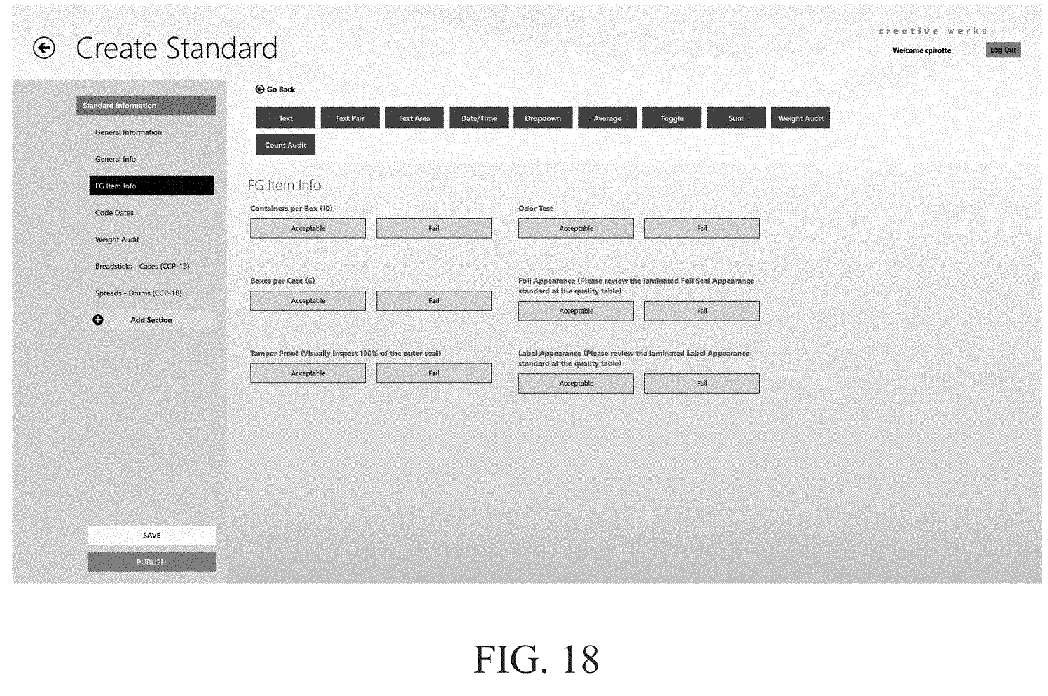

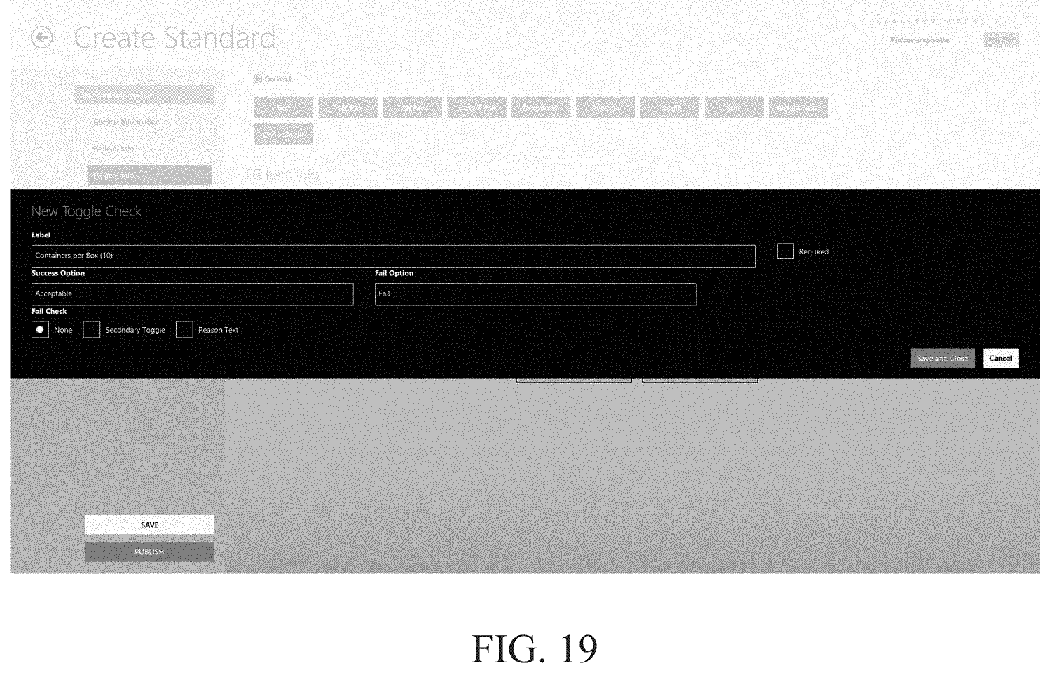

Thus, in an embodiment, the toggle may be a pass/fail toggle that allows the user to choose pass or fail, and if fail is chosen, at least one secondary check is presented to said user requiring the input of additional data (see FIG. 18-19).

In a variation, the established product rules may include one or more or weight, count number, count audit, average weight, weight audit, sum weight, or appearance. The user will input data regarding any one of these product rules either by manually entering the data or by use of a peripheral device.

In one embodiment, the present invention relates not just to systems but also methods of using the system. In one embodiment, the present invention relates to a method of ascertaining the quality of packaged and/or manufactured goods, said method comprising formulating a quality control plan and implementing said plan to ascertain the quality of said packaged and/or manufactured goods, wherein said quality control plan comprises at least one quantitative or qualitative check that allows for a user to input data on a tablet or mobile computing device that tests said at least one quantitative or qualitative check, wherein said input data is compared to said at least one quantitative or qualitative check, producing results regarding the quality of the packaged and/or manufactured goods. When the input data is compared to said at least one quantitative or qualitative check, the tablet or mobile computing device performs an operation that will compare the input data to a standard that has been input by the administrator. For example, a deviation from an average input data (by the user) might prove to be larger than the standard deviation from average that is set by the administrator when setting up the check. In one embodiment, if this occurs (i.e., the input data deviation is larger than the standard deviation), the tablet and/or mobile computing device may alert the user with a warning. The warning may be that the background of the input data turns red making the alert extremely apparent to the user (e.g., technician).

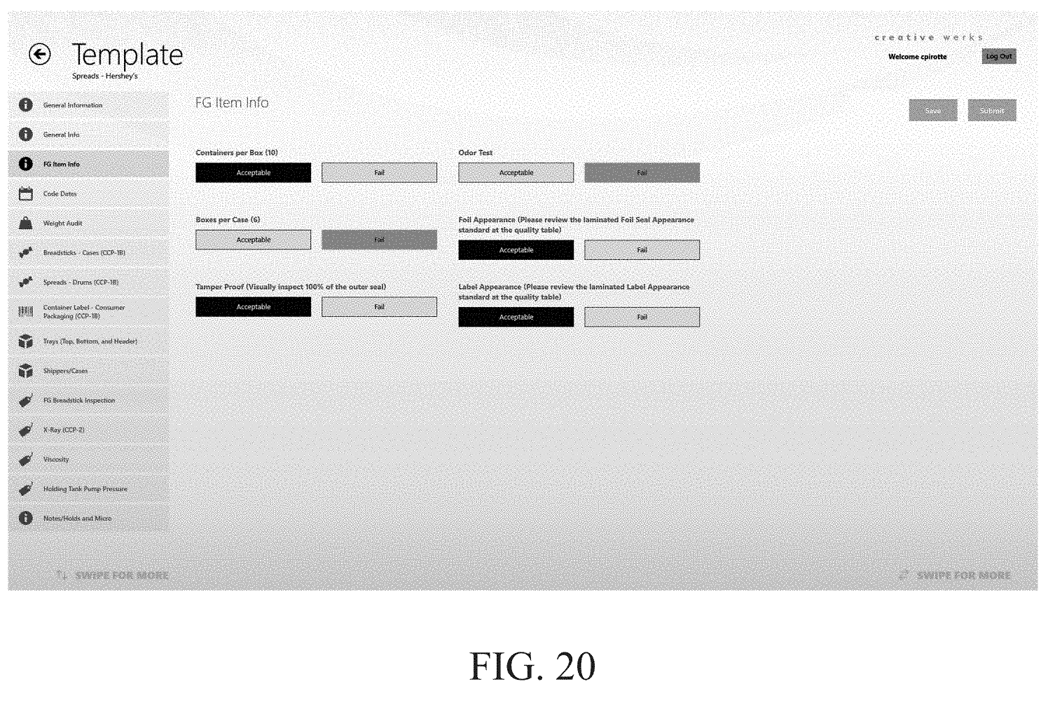

Accordingly, in one embodiment, the method may further comprise a step of having an administrator enter and/or program the at least one quantitative or qualitative check onto the tablet or mobile computing device. This provides a standard against which data that is input by the user is compared. It should be noted that the check may be a yes/no toggle or a pass/fail toggle or a check that requires the input of text data (e.g., numeric or alphanumeric data) (see FIG. 20).

In one variation the quality control plan comprises a plurality of quantitative or qualitative checks. The number of quantitative or qualitative checks may need to be repeated a number of times. For example, the method should do sufficient checks in order to get a sufficient sample size that gives meaningful data (e.g., standard deviation numbers).

In one embodiment of the method, the present invention relates to having the input data input by a peripheral device. In one variation, the peripheral device is one or more of a mouse, a stylus, a weigh scale, a bar scanner, a temperature reader, a moisture sensor, a RFID sensor, and/or a counter that comprises a light beam used for counting.

In one variation of the method, the administrator may enter and/or program the at least one quantitative or qualitative check to be one or more or a toggle, a drop down menu, or the entry of text. Thus, the administrator will determine what information the user needs to enter when doing the check. The administrator may provide the user with boxes that allow the user (e.g., the technician) to select one of a plurality of boxes (for example, there may be two boxes with one allowing the user to check “pass” or “fail”). The administrator may also cause the user to enter data from a dropdown menu wherein there are a plurality of choices from which the user can choose. Alternatively, the administrator may cause the user to enter text data (for example, the user may need to input a number in a box for weight). The administrator may also design the check so that the user is able to use a peripheral device that automatically enters/inputs the data (for example, a weigh scale).

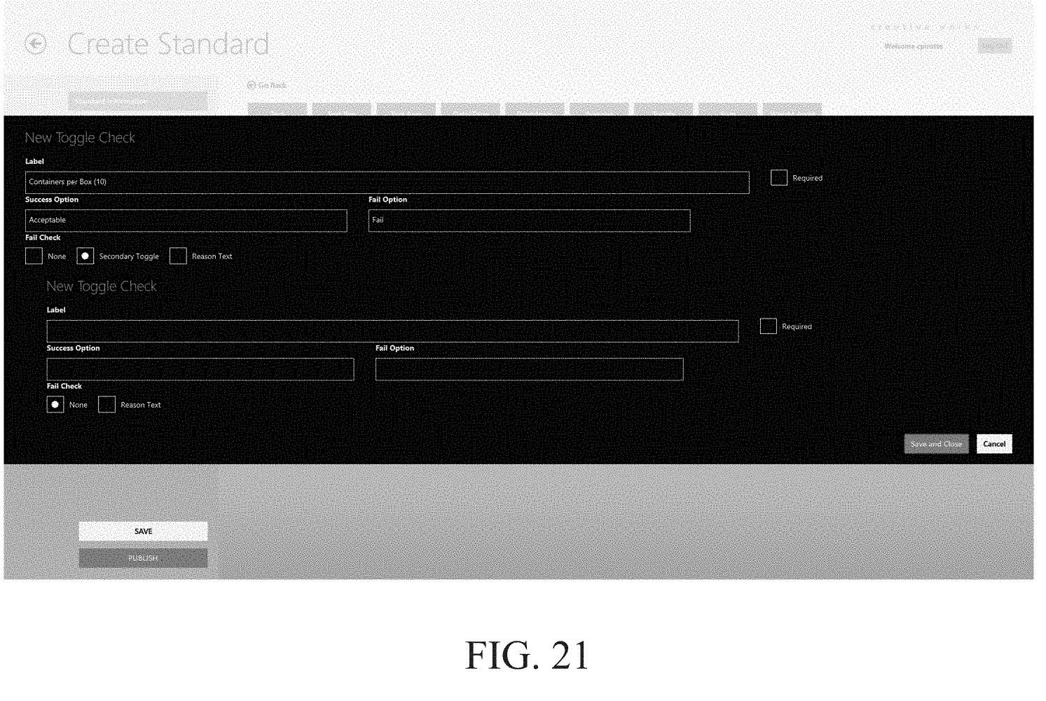

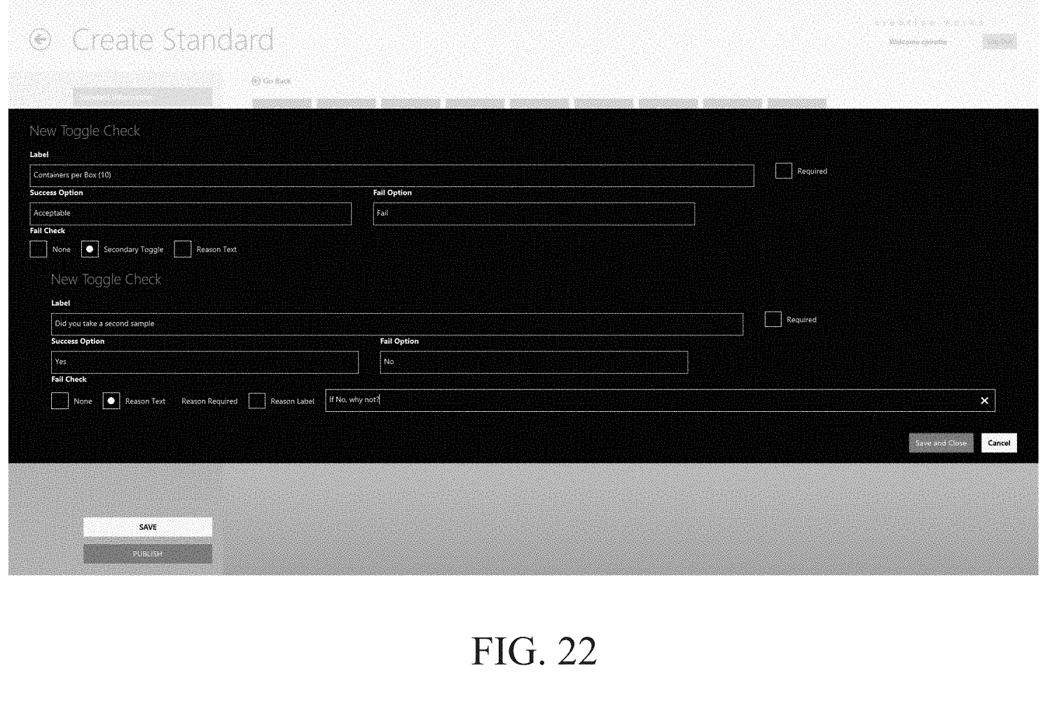

In an embodiment, the at least one quantitative or qualitative check is a toggle that allows a user to input data regarding the goods. In one variation, the toggle is a pass or fail toggle (see FIG. 21). In a variation, if the user (e.g., technician) inputs fail, the quality control plan comprises at least one secondary quantitative or qualitative check (see FIG. 22). In a variation, the at least one quantitative or qualitative check comprises a query that ascertains a deviation from a standard of the good. The standard is the number that is input by the administrator to which input data is compared. For example, the administrator would input a standard for ideal weight of a product and the ideal deviation (weight) of the product. The user would then input the actual weight of the product and the program would perform an operation that compares the actual weight to the ideal weight and would also subtract the ideal weight from the actual weight to give an actual deviation from the ideal weight. If the actual deviation is bigger than the ideal deviation, the user will be alerted that this is the case (for example, the background of the deviation would turn red). The user might then stop and/or alter the production process to address this issue.

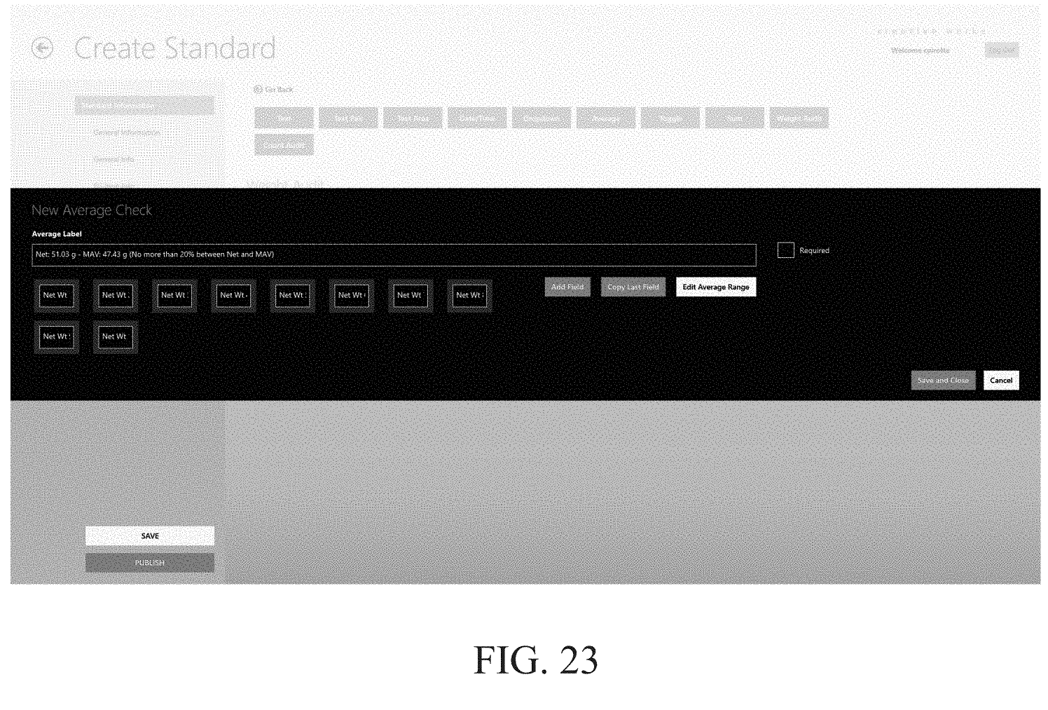

Any of a plurality of standards can be set by the administrator. For example, the standard of the good can be any one or more of weight, count number, count audit, average weight (see FIG. 23), weight audit, sum weight, or appearance.

In an embodiment the administrator and the user may be the same person/entity.

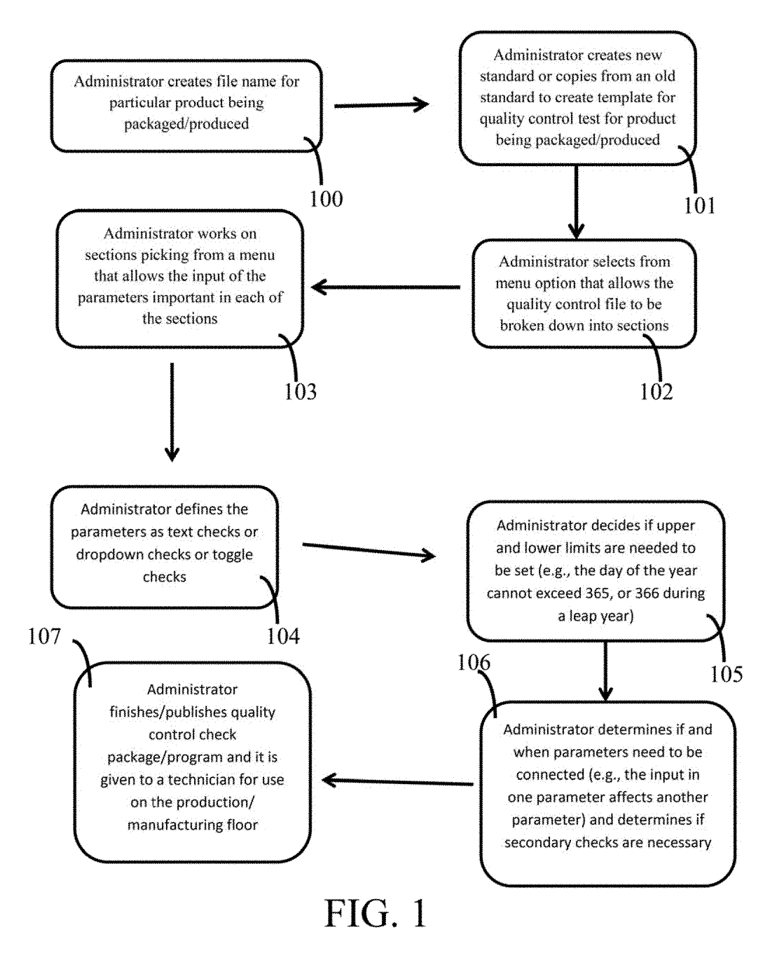

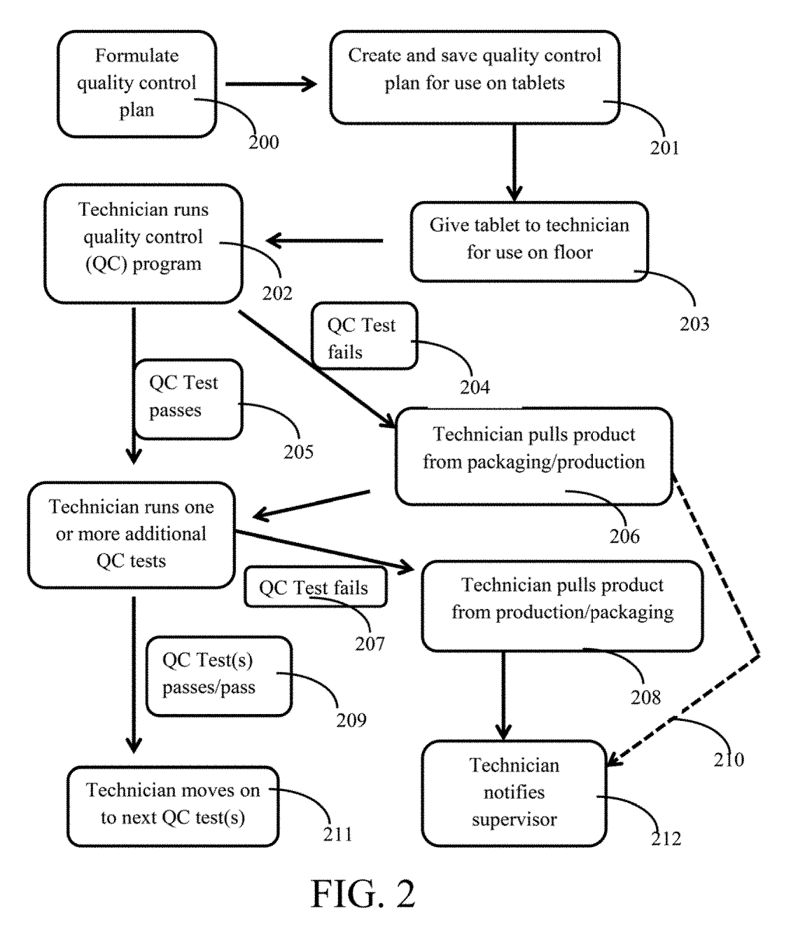

The invention is also described herein in relation to FIGS. 1 and 2.

In FIG. 1, a sample check assurance program is illustrated that lays out how a quality assurance system of the present invention may be input. FIG. 1 is a subset of FIG. 2 and shows illustrative steps that correlate with the steps 200, 201, and 203 from FIG. 2. FIG. 1 shows the planning and process of making the quality assurance program, which is eventually turned over to the technician for use on the floor. Initially, the administrator creates a file name for a particular product being packaged/produced 100. The file name generally is named so that it can readily be located by the technician when it is used on the floor. Thus, the file should also be associated with either a product or a client (internal or external client) that is using the file. Subsequently, the administrator creates a new standard or copies from an old standard to create a template for a quality control test for the product that is being packaged/produced 101. Generally, the administrator selects from several menu options that allow the quality control file to be broken down into sections 102. Each section should be self-contained and make sense so that the technician can go through each section when the technician (user) is performing the checks on the manufacturing floor. The administrator works on sections picking from a menu that allows the input of the parameters important in each of the sections 103. The administrator defines the parameters as text checks or dropdown checks or toggle checks 104. These different parameters as determined by the administrator make the user enter/input data in the requisite form. The administrator decides if upper and lower limits are needed to be set (e.g., the day of the year (the Julian date) cannot exceed 365, or 366 during a leap year) 105. The administrator than sets the upper and lower limits as needed. The administrator will also determine if and when parameters need to be connected (e.g., the input in one parameter affects another parameter) and determines if secondary checks are necessary 106. For example, if the administrator enters an ideal weight and enters a box for the actual weight, the administrator will realize that to get a deviation from the ideal weight, that the ideal and actual weight need to be connected (which will in turn also be connected to the deviation from the ideal weight). The administrator finishes/publishes the quality control check package/program and the tablet is given to a technician for use on the production/manufacturing floor 107.

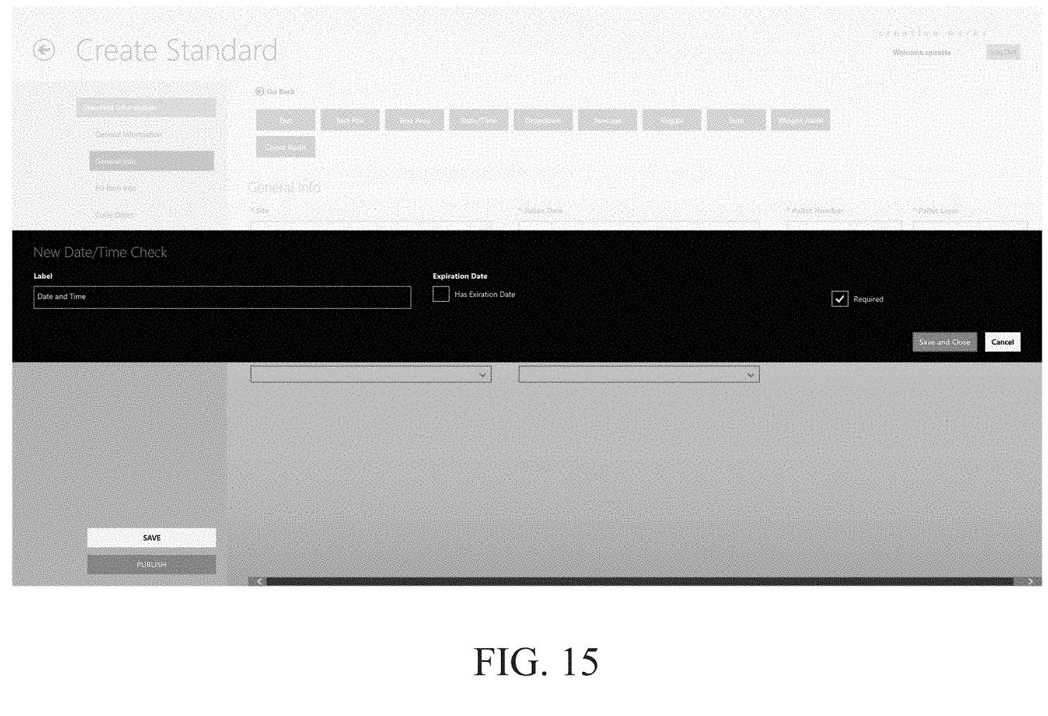

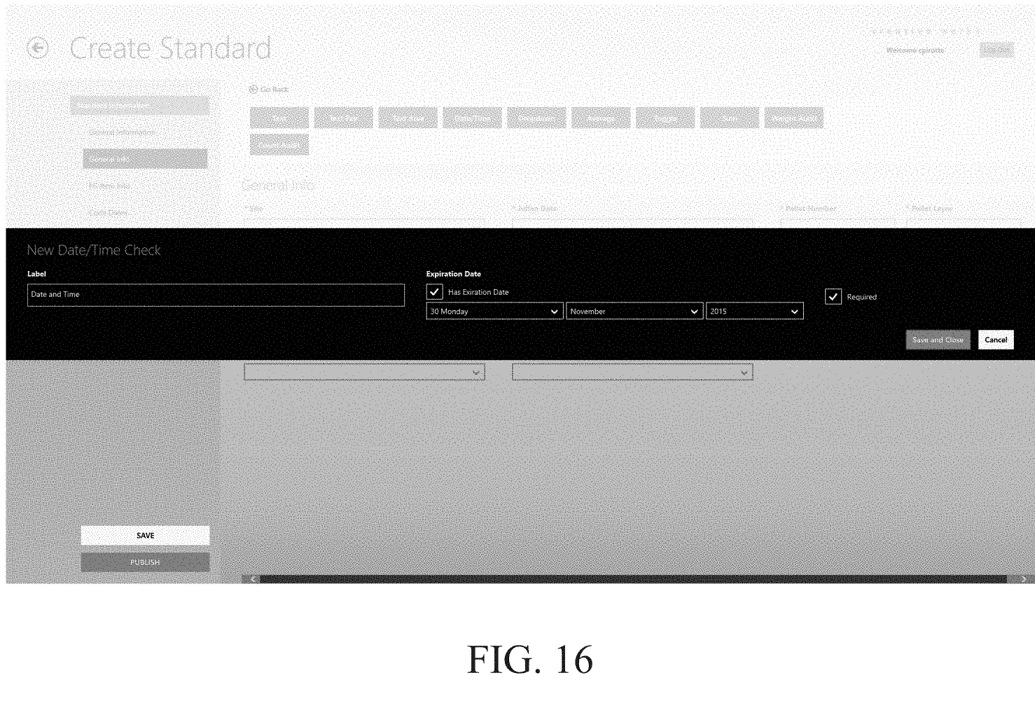

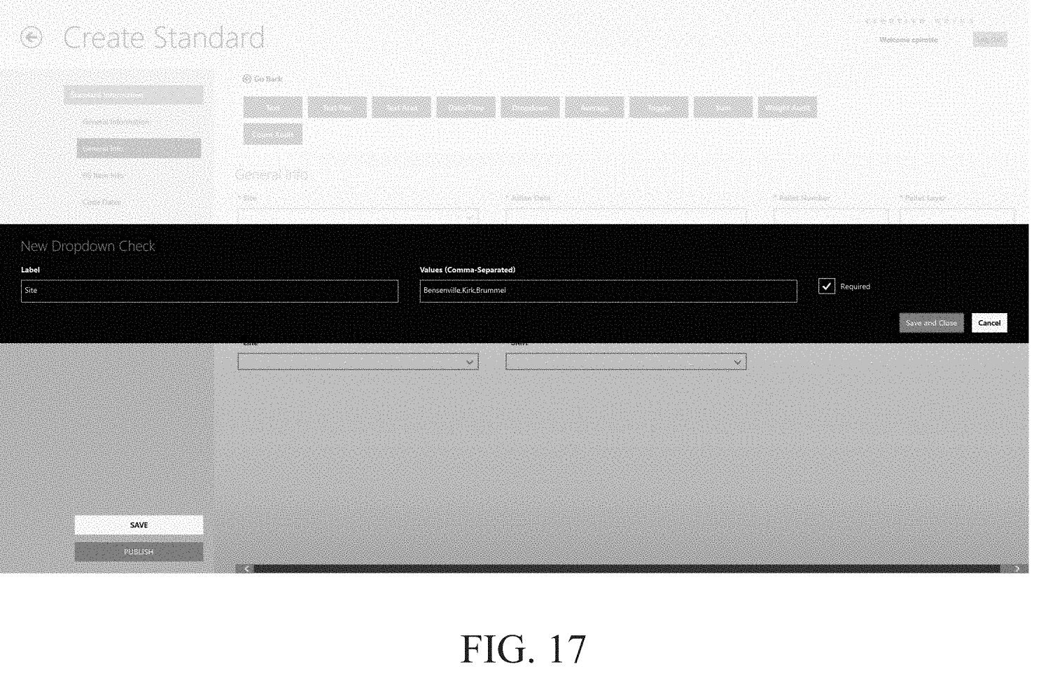

In FIG. 2, a flowchart is given explaining one embodiment of a quality assurance process of the present invention. Initially, administrators formulate a quality control plan 200 that is dependent upon the product being produced/packaged. The administrator generally will create a file for the particular product that will require a quality assurance process. The administrator may be asked by the software if the administrator may add one or more of a number of possible checks that the technician may use when the technician goes to the floor. For example, the administrator may add one or more of following options: texts, date/time (see FIGS. 15-16), dropdown (see FIG. 17), average, toggle (pass/fail) (see FIG. 18), weight audit, and count audit. Usually, the underlying software program is written that allows the administrator to pick the desired checks in a very user friendly manner. For example, the administrator might simply use a mouse to pick the one or more desired checks by using point and click on said one or more checks. The administrator may have the ability to modify any of these checks such as by adding the number of products that go in a package in a count audit. Similarly, the administrator may have the ability to modify (or input) requisite minimum weight in a weight audit.

In FIG. 2, formulating the quality control plan 200, creating and saving the quality control plan for use on tablets 201, and giving the tablet to technician for use on a floor 203 were all discussed with reference to FIG. 1. FIG. 2 is a flowchart that illustrates one process that can be followed using the systems and methods of the present invention and it is meant to be simply a non-limiting example. Variations of this process are contemplated and therefore within the scope of the invention.

Once the technician receives the tablet with the quality control plan, the technician goes to the floor where he runs/executes the quality control plan (program) 202. A user (e.g., the technician) will input real data that he gets from the product that is being manufactured/packaged. If the input data meets specifications (i.e., the check passes 205), the technician will run additional tests until he has performed the requisite number of checks (which is determined by the control plan). Generally, if the check passes, the tablet or mobile computing device will not indicate an alert and the technician is encouraged to continue running checks until he has performed the requisite number of checks. If the check fails 204, the technician will generally pull the product from the production/packaging line 206. The technician will then perform additional tests. If the quality control check fails 207, the technician will again generally pull the product from the production/packaging line 208 and he may be instructed by the quality control plan to notify a supervisor 212. If the technician runs one or more additional tests and the checks all pass 209, the technician after he has run the requisite number of checks (as determined by the administrator who plans and makes the quality control plan), the technician may move on the next quality control tests he will perform 211. If the checks do not meet specifications, the technician will again pull the product from the production/packaging line 206, 208 and if a sufficient number do not pass the check, the tablet may tell the technician to notify a supervisor 212 for further action (e.g., stopping and or amending production/packaging until the checks meet tests).

It should be understood that the present invention is not to be limited by the above description. Modifications can be made to the above without departing from the spirit and scope of the invention. It is contemplated and therefore within the scope of the present invention that any feature that is described above can be combined with any other feature that is described above (even if those features are not described together). Moreover, it should be understood that the present invention contemplates and it is therefore within the scope of the invention that any element or feature can be added and/or omitted in the processes, systems and methods and those modifications to the production process, systems and methods are still within the scope of the present invention. In any event, the scope of protection to be afforded is to be determined by the claims which follow and the breadth of interpretation which the law allows.

We claim:

1. A quality assurance system for ascertaining the quality of packaged and/or manufactured goods, wherein said system comprises one or more tablets and/or mobile computer devices that allows for a user to collect and input data on said goods on said one or more tablets and/or mobile computer devices, wherein said data is collected and input in real-time and collated in real time to allow for substantially instantaneous review against established product rules, said instantaneous review against established product rules allowing the user to ascertain the quality of the packaged and/or manufactured goods.

2. The quality assurance system of claim 1, wherein the established product rules are input by an administrator.

3. The quality assurance system of claim 2, wherein the established product rules comprise checks that the user uses as a guide to collect and input data on said goods on said one or more tablets and/or mobile computer devices.

4. The quality assurance system of claim 3, wherein the checks comprise one or more of data that can be collected by the user and input as text, input from a dropdown menu, or input using a toggle.

5. The quality assurance system of claim 4, wherein the system further comprises a mouse, a stylus, or a peripheral device that is used to input data.

6. The quality assurance system of claim 5, wherein the peripheral device is one or more of a weigh scale, a bar scanner, a temperature reader, a moisture sensor, a RFID sensor, and a counter that comprises a light beam used for counting.

7. The quality assurance system of claim 4, wherein the toggle is present in the system and the toggle is a pass/fail toggle.

8. The quality assurance system of claim 7, wherein the toggle is a pass/fail toggle that allows the user to choose pass or fail, and if fail is chosen, at least one secondary check is presented to said user.

9. The quality assurance system of claim 1, wherein said established product rules include one or more or weight, count number, count audit, average weight, weight audit, sum weight, or appearance.

10. A method of ascertaining the quality of packaged and/or manufactured goods, said method comprising formulating a quality control plan and implementing said plan to ascertain the quality of said packaged and/or manufactured goods, wherein said quality control plan comprises at least one quantitative or qualitative check that allows for a user to input data on a tablet or mobile computing device that tests said at least one quantitative or qualitative check, wherein said input data is compared to said at least one quantitative or qualitative check, producing results regarding the quality of the packaged and/or manufactured goods.

11. The method of claim 10, further comprising a step of having an administrator enter and/or program the at least one quantitative or qualitative check onto the tablet or mobile computing device.

12. The method of claim 11, wherein said quality control plan comprises a plurality of quantitative or qualitative checks.

13. The method of claim 11, wherein the input data is input by a peripheral device.

14. The method of claim 13, wherein the peripheral device is one or more of a mouse, a stylus, a weigh scale, a bar scanner, a temperature reader, a moisture sensor, a RFID sensor, and a counter that comprises a light beam used for counting.

15. The method of claim 14, wherein the administrator enters and/or programs the at least one quantitative or qualitative checks to be one or more or a toggle, a drop down menu, or the entry of text.

16. The method of claim 15, wherein the at least one quantitative or qualitative check is a toggle that allows a user to input data regarding the goods.

17. The method of claim 16, wherein the toggle is a pass or fail toggle.

18. The method of claim 17, wherein if the user inputs fail, the quality control plan comprises at least one secondary quantitative or qualitative check.

19. The method of claim 10, wherein said at least one quantitative or qualitative check comprises a query that ascertains a deviation from a standard of the good.

20. The method of claim 19, wherein the standard of the good is one or more of weight, count number, count audit, average weight, weight audit, sum weight, or appearance.
